(19) United States
(12) Patent Application Publication
(10) Pub. No.: US 2020/0141900 A1
(43) Pub. Date: May 7, 2020

(54) PRECAST ELECTROPHORESIS GEL PACKAGE

(71) Applicant: SMOBIO Technology, Inc., Hsinchu City (TW)

(72) Inventor: KUAN-LIN LEE, Hsinchu City (TW)

(73) Assignee: SMOBIO Technology, Inc., Hsinchu City (TW)

(21) Appl. No.: 16/515,016

(22) Filed: Jul. 17, 2019

(30) Foreign Application Priority Data
Nov. 6, 2018 (CN) 201821816143.X

(51) Int. Cl. G01N 27/447

(52) U.S. Cl. CPC G01N 27/44747

(57) ABSTRACT

This disclosure relates to a precast electrophoresis gel package that avoids deformation of the precast electrophoresis gel, including: an enclosure, including a cavity and a skirt encompassing and connected to the cavity; a precast electrophoresis gel assembly, being encased by the cavity of the enclosure, with an edge thereof contacting with the surrounding of the cavity of the enclosure; and a sealing membrane, being attached with the skirt and completely covering the cavity of the enclosure.

### CROSS-REFERENCES TO RELATED APPLICATIONS

The present application claims priority to China Patent Application No. 201821816143.X, filed Nov. 6, 2018, which incorporated herein by reference n its entire

### FIELD OF THE INVENTION

This invention relates to a precast electrophoresis gel package, and more particularly to a precast electrophoresis gel package that avoids deformation of the precast electrophoresis gel.

### BACKGROUND OF THE INVENTION

Electrophoresis is a commonly used method for identifying and isolating biological macromolecules in the field of molecular biology. The principle is to utilize the differences in the speed these molecules will travel within a medium under the influence of an electric field because of a difference in molecular weight and charge value between different biomacromolecules. The result of this process is a separation and isolation of biological macromolecules.

The medium commonly used in electrophoresis to separate biomacromolecules is an electrophoretic gel, which is generally flat and has regularly-spaced wells to hold the macromolecules to be tested. In general, electrophoretic gels are divided into two major types: agarose gels and polyacrylamide gels. Agarose gels are relatively easy to manufacture and their main ingredients are derived from polysaccharide polymers in seaweed. Although the pore sizes of agarose gels are less uniform, the separation effect on the DNA fragment and proteins larger than 200 kDa is better. Polyacrylamide gels have relatively smaller and more uniform pore sizes compared to agarose gels and are therefore commonly used to separate proteins. In addition, polyacrylamide gels generally have better resolution and are therefore more expensive than agarose gels. However, it should be noted that polyacrylamide gel powder is toxic and should be used with care.

In the past, most laboratories used their own electrophoresis gels. However, the benefits of using pre-formed electrophoretic gel were quickly discovered: they saved time and were easier to produce accurate, consistent results with. Today's precast electrophoresis gels are mostly packaged in a soft shell coated prefabricated electrophoretic adhesive combination. The precast gel assembly comprises a pair of two plates capable of combining convex and concave edges, and the cover has a space for accommodating the electrophoresis gel.

In the prior art, most of the precast electrophoresis gel is packaged inside a soft plastic or aluminum covering. If it is squeezed by an external force, all the force is taken up by the upper and lower plates composing the assembly, which will cause the gel to be squeezed and deformed. Some of the more advanced packaging is vacuum formed with a soft plastic film, so that the soft outer film is in contact with the upper and lower plates of the pre-cast electrophoresis gel assembly. The forces are not distributed upon the outer packaging; rather, most all the force is still bore by the upper and lower plates. This more advanced packaging has the same result of the gel being directly squeezed, and the accuracy of the experimental results affected. Therefore, today's precast electrophoretic gel packaging needs to be further improved to avoid deformation of the precast electrophoretic gel.

### BRIEF SUMMARY OF THE INVENTION

This invention relates to a precast electrophoresis gel package that avoids deformation of the precast electrophoresis gel, comprising: an enclosure, including a cavity and a skirt encompassing and connected to the cavity; a precast electrophoresis gel assembly, being encased by the cavity of the enclosure, with an edge thereof contacting with the surrounding of the cavity of the enclosure; and a sealing membrane, being attached with the skirt and completely covering the cavity of the enclosure.

### BRIEF DESCRIPTION OF THE DRAWINGS

FIG. 1 is a combination view of a precast electrophoretic gel package 100, according to a preferred embodiment of this invention, comprising an enclosure 110, a precast electrophoretic gel assembly 120, and a sealing membrane 130.

FIG. 2 is a cross-sectional view of a precast electrophoretic gel package 100 according to a preferred embodiment of this invention. The precast electrophoretic gel package 100 includes an enclosure 110 having a cavity 112 and a skirt 114 connected to the periphery of the cavity 112; The precast electrophoretic gel assembly 120 is placed in a cavity 112 in the enclosure 110 such that the edge of the precast electrophoretic gel assembly 120 contacts the perimeter within the cavity 112 in the enclosure 110; and a sealing membrane 130 that completely covers the cavity 112 in the enclosure 110.

FIG. 3 is an enclosure 110 of a precast electrophoretic gel package 100 having a cavity 112 and a skirt 114 connected to the periphery of the cavity 112 in accordance with a preferred embodiment of this invention.

FIG. 4A is a precast electrophoretic gel assembly 120 of a precast electrophoretic gel package 100 in accordance with a preferred embodiment of this invention.

FIG. 4B is a precast electrophoretic gel assembly 120 of a precast electrophoretic gel package 100 in accordance with a preferred embodiment of this invention. FIG. 4B shows an exploded view of the precast electrophoretic gel assembly 120, comprising: a first plate 122; a second plate 124 having a joint flange on each of the left and right sides in order for the first plate and the cover of the second plate to create a space for housing an electrophoretic gel 128; a comb 126; and an electrophoretic gel 128. The comb 126 is disposed in the space in which the electrophoresis gel 128 is accommodated.

FIG. 5 shows a sealing membrane 130 of a precast electrophoretic gel package 100 according to a preferred embodiment of this invention, the corner of which further comprises a tear strip 132 for conveniently disassembling the pre-formed electrophoretic gel package 100.

### DETAILED DESCRIPTION OF THE INVENTION

This invention is to provide a precast electrophoresis gel package that avoids deformation of the precast electrophoresis gel by force-induced extrusion.

This invention relates to a precast electrophoresis gel package, comprising: an enclosure, including a cavity and a skirt encompassing and connected to the cavity; a precast electrophoresis gel assembly, being encased by the cavity of the enclosure, with an edge thereof contacting with the surrounding of the cavity of the enclosure; and a sealing membrane, being attached with the skirt and completely covering the cavity of the enclosure.

The cavity of the enclosure of the invention is completely integrated with the precast electrophoresis gel assembly, and, during transportation or storage, the space is squeezed or when the electrophoresis gel expands and swells, the comb can be effectively prevented from being expelled from the assembly, and the precast electrophoresis gel can be effectively presented from being deformed.

The skirt at the edge of the cavity in the enclosure not only helps to provide adhesion to the sealing membrane, but also helps the precast electrophoresis gel to withstand impacts to the package during collision, especially during the transportation.

The manufacturing process of the outer casing can utilize vacuum forming or thermoforming using a hard film material, that is, a so-called blister pack; or plastic injection molding. Materials that can be used for the outer casing include, but are not limited to, polyethylene (PE), polypropylene (PP), polyethylene terephthalate (PET or PETE), and copolyester (Poly (ethylene terephthalateco). -1,4-cylclohexylenedimethylene terephthalate), PETG), Polyvinyl Chloride (PVC), AS, Polystyrene (PS), Polycarbonate (PC), Polylactic Acid (Polylactic Acid or Polylactide), PLA), acrylic, etc.

### Description of Embodiments

### EXAMPLES

The examples below are non-limiting and are merely representative of various aspects and features of the present invention.

### Example 1

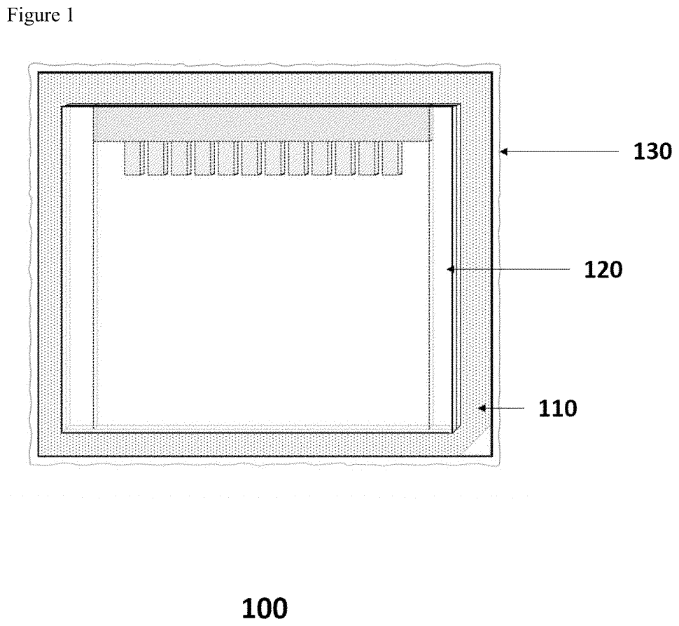

Referring to FIG. 1, a diagram of a precast electrophoretic gel package 100, in accordance with a preferred embodiment of this invention, is given. The precast electrophoretic gel package 100 comprises: an enclosure 110; a pre-formed electrophoresis gel assembly 120; and a film 130.

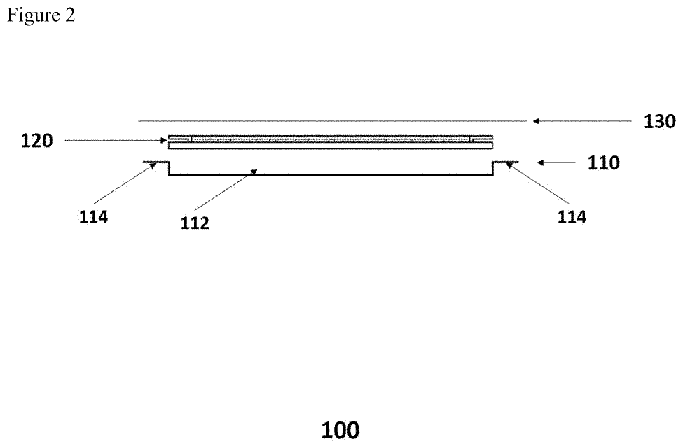

FIG. 2 is a cross-sectional view of a precast electrophoretic gel package 100 according to a preferred embodiment of this invention. The precast electrophoretic gel package 100 comprises an enclosure 110 having a cavity 112 and a skirt 114 connected to the periphery of the cavity 112; a precast electrophoretic gel assembly 120 encased within the cavity 112 in the enclosure 110 such that the edge of the precast electrophoretic gel assembly 120 contacts the perimeter within the cavity 112 in the enclosure 110; and a film 130, which is installed so that it completely covers cavity 112 in the outer enclosure 110. It should be noted that the pre-formed electrophoretic gel assembly 120 should be sized to coincide with the cavity 112 in the enclosure 110 so that the pre-formed electrophoretic gel assembly 120 does not jiggle when placed in the cavity 112 in the enclosure 110 so as to achieve shock absorption and a protective effect. At the same time, the advantages of the precast electrophoretic gel assembly 120 in conformity with the cavity 112 in the enclosure 110 include preventing the comb 126 from being ejected due to extrusion or galvanic expansion of the electrophoretic gel 128, affecting the integrity of the pre-formed electrophoretic gel assembly 120.

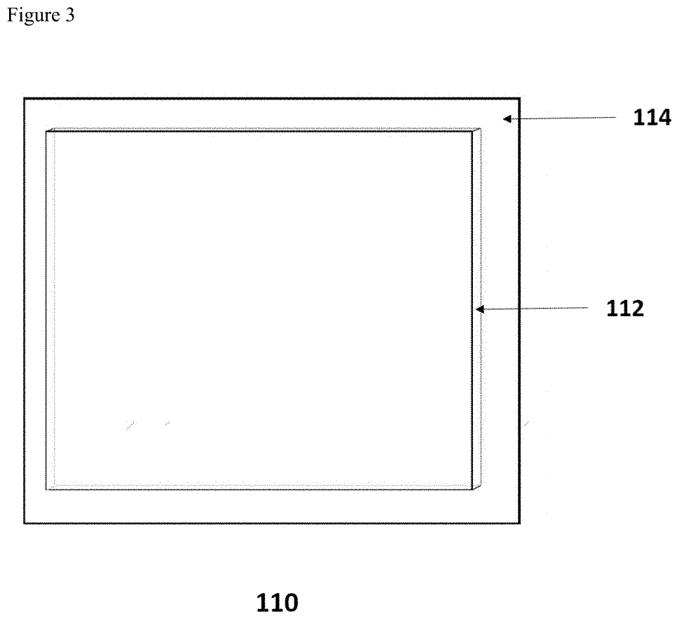

Referring to FIG. 3, an enclosure 110 of a precast electrophoretic gel package 100 having a cavity 112 and a skirt 114 connected to the periphery of the cavity 112 is shown in a preferred embodiment of this invention.

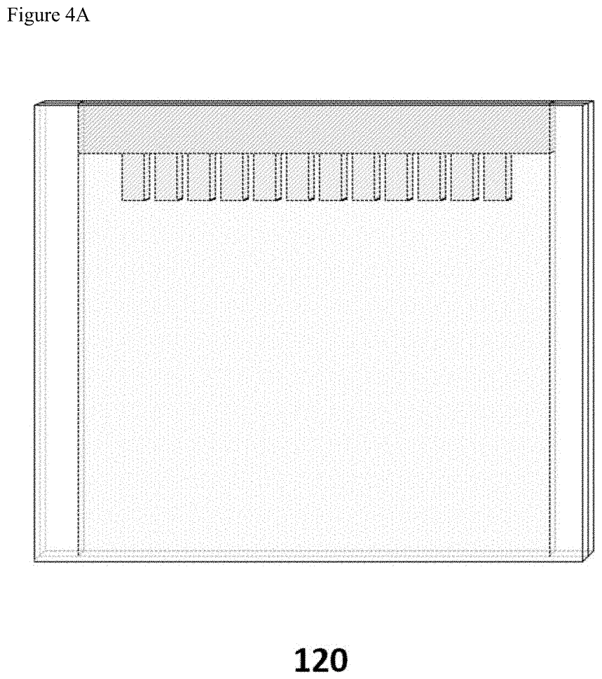

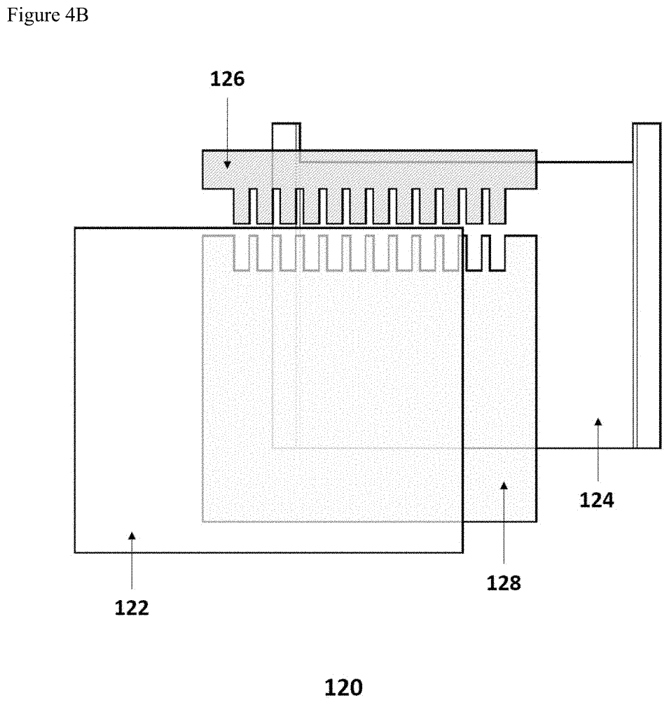

FIG. 4A and 4B, a precast electrophoretic gel assembly 120 of a precast electrophoretic gel package 100 in accordance with a preferred embodiment of this invention. FIG. 4A shows a precast electrophoretic gel combination 120. FIG. 4B shows an exploded view of the precast electrophoretic gel assembly 120, comprising: a first plate 122; a second plate 124 having a joint flange on each of the left and right sides for the first plate and the cover of the second plate is used to create a space for housing an electrophoretic gel 128; a comb 126; and an electrophoretic gel 128. The comb 126 is disposed in the space in which the electrophoresis gel 128 is accommodated.

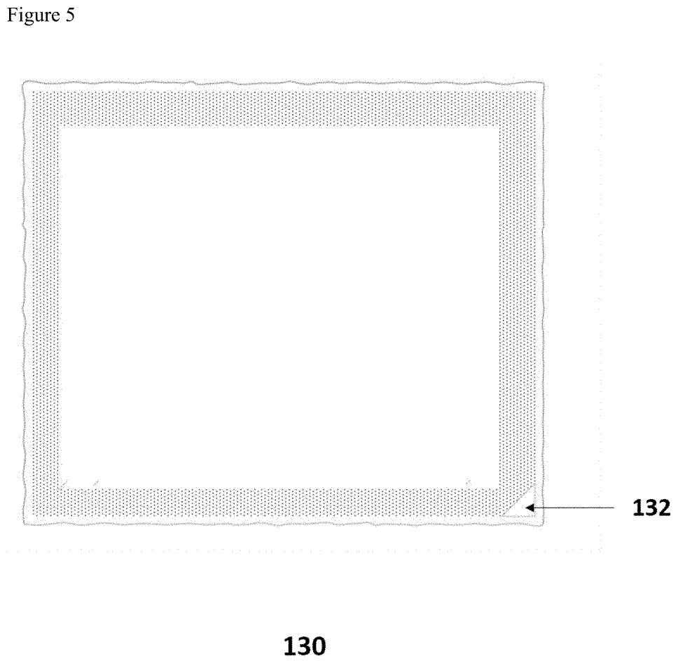

Referring to FIG. 5, a sealing membrane 130 of a precast electrophoretic gel package 100 according to a preferred embodiment of this invention further includes a tear strip 132 for conveniently disassembling the pre-formed electrophoretic gel package.

In another preferred embodiment, the enclosure 110 is a blister pack. The blister package is harder than the past soft plastic package, and can disperse the longitudinal pressure during stacking to avoid the precast electrophoretic gel assembly 120 from being crushed.

In another preferred embodiment, the skirt 114 has a width of at least 2 mm. The skirt 114 having a width of 2 mm or more can be used as a buffer in addition to being adhered to the sealing membrane 130, thereby effectively reducing deformation or damage caused by the extrusion or lateral force colliding with the pre-made electrophoretic gel assembly 120.

While the invention has been described and exemplified in sufficient detail for those skilled in this art to make and use it, various alternatives, modifications, and improvements should be apparent without departing from the spirit and scope of the invention.

One skilled in the art readily appreciates that the present invention is well adapted to carry out the objects and obtain the ends and advantages mentioned, as well as those inherent therein. The cells, animals, and processes and methods for producing them are representative of preferred embodiments, are exemplary, and are not intended as limitations on the scope of the invention. Modifications therein and other uses will occur to those skilled in the art. These modifications are encompassed within the spirit of the invention and are defined by the scope of the claims.

What is claimed is:

1. A precast electrophoresis gel package, comprising:
an enclosure, including a cavity and a skirt encompassing and connected to the cavity;
a precast electrophoresis gel assembly, being encased by the cavity of the enclosure, with an edge thereof contacting with the surrounding of the cavity of the enclosure; and
a sealing membrane, being attached with the skirt and completely covering the cavity of the enclosure.

2. A precast electrophoresis gel package, as claimed in claim 1, wherein the precast electrophoresis gel assembly further includes:
a first plate;
a second plate, including an engaging flange at a left side and a right side thereof, for covering the first plate and the second plate to generate a space for housing electrophoresis gel; and
a comb, encased by the space for filling the electrophoresis gel.

3. A package for a precast electrophoretic gel as claimed in claim 1, wherein the enclosure is a blister pack.

4. A package for a precast electrophoretic gel as claimed in claim 1, wherein a width of the skirt connected with the surrounding of the cavity in the enclosure is greater or equal to 2 mm.

5. A package for a precast electrophoretic gel as claimed in claim 1, wherein the sealing membrane further includes a tearing strip to facilitate removal of the package for a precast electrophoretic gel.
